(19) United States
(12) Patent Application Publication
(10) Pub. No.: US 2012/0156382 A1
(43) Pub. Date: Jun. 21, 2012

(54) 2-COMPONENT LAMINATING ADHESIVE

(75) Inventors: Holger Eichelmann, Hilden (DE); Michael Hoeltgen, Duesseldorf (DE)

(73) Assignee: Henkel AG & Co, KGaA, Duesseldorf (DE)

(21) Appl. No.: 13/325,143

(22) Filed: Dec. 14, 2011

Related U.S. Application Data
(63) Continuation of application No. PCT/EP2010/056310, filed on May 10, 2010.

(30) Foreign Application Priority Data
Jun. 30, 2009 (DE) 10 2009 027 329.8

(51) Int. Cl. C08L 63/00; B05D 3/10; C08K 5/05

(52) U.S. Cl. 427/386; 523/406; 523/456; 523/461; 523/425; 523/435; 523/400

(57) ABSTRACT

The invention relates to a two-component composition consisting of a component A containing a polymer with a molecular weight of 250 to 5000 g/mol which has at least 2 epoxy groups per molecule, a component B containing a compound of the formula (I) R₁-phenyl-(—O—R₂)ₐ where R₁=H, C₁ to C₆-alkyl, a=1, 2, or 3, R₂=—O—CH₂—CHOH—CH₂—NH—CH₂-phenyl-CH₂—NH₂, wherein the epoxy/NH ratio of the components A to B is between 0.75:1 to 1.25:1.

The invention relates to a two-component binding agent based on an epoxide component and an amino component that comprise a high proportion of aromatic constituents. The invention further relates to a two-component laminating adhesive and a two-component coating agent that contain this binding-agent system.

U.S. Pat. No. 7,282,543 is known. This describes an aqueous-based composition which contains a polyepoxide resin that comprises at least one tertiary amino group, the amino group comprising one or two substituents that each carry an epoxy group. Aqueous polyamino compounds are described as crosslinkers.

EP 1 086 190 is known. This describes a reactive system for film substrates that encompasses an epoxy resin based on bisphenol A or F, resorcinol, or aliphatic polyols having epoxide groups, as well as a crosslinker based on compounds having an amino group or carboxyl group. Crosslinkers containing aromatic groups are not described.

DE 4128487 is known. This describes epoxide dispersions that can crosslink via amine hardeners. The epoxide binding agents are described here as reaction products of aromatic polyols and polyepoxides. Amine-containing polyepoxides are not described, and amines having aromatic nuclei and primary amino groups are thus not described.

EP 1 219 656 is also known. This claims a coating composition having gas barrier properties, one component being an epoxy resin that comprises at least one epoxy-amine unit and is a derivative of mXDA, and the hardener being a compound by reacting XDA with monocarboxylic acid and polyfunctional compounds which then form an amide group.

EP 1 437 393 is also known. This claims an adhesive having an epoxy resin component and a hardener for said epoxy resins, the epoxy resin comprising at least 40% XDA structures.

In the case of the two-component coating agents of the existing art, mXDA or pXDA is generally used as a crosslinker. These are primary aromatic amines. Such amines can migrate into the film materials under a variety of environmental conditions. Such amines are therefore to be contained, if at all possible, in a reduced quantity in adhesives that, in the adhesively bonded product, can come into contact with foods.

A further disadvantage of the systems described above is the high viscosity of the mixed adhesive, so that application in a thin layer is often problematic. It is known that organic solvents can be added in order to dilute the reaction mixture. Such organic solvents must, however, be removed from the layer before bonding or before further processing. This additional method step is laborious; in addition, for reasons of industrial hygiene it is necessary for such solvents to be drawn off and destroyed.

An object of the present invention is therefore to make available a two-component composition that is made up of an epoxy resin and low-viscosity amine reaction products. A further subject of the invention is two-component laminating adhesives or two-component coating agents based on the two-component composition. A further subject of the invention is the use of such coating agents for the manufacture of coated films that exhibit only a low level of permeability to gaseous or diffusable substances, for example oxygen or aroma chemicals. A further object of the invention is to make available adhesives or coating agents, made from corresponding binding agents, that exhibit a low processing viscosity without the addition of solvents.

The invention is achieved by way of a two-component composition made up of a component A containing a polymer having a molecular weight from 250 to 5000 g/mol and having at least two epoxide groups per molecule, and a component B containing at least compound of formula (I)

R¹-phenyl-(O—R²)ₐ (I)

where
R¹=H, C₁ to C₆ alkyl
R²=—O—CH₂—CHOH—CH₂—NH—CH₂-phenyl-CH₂—NH₂,
a=1, 2 or 3
   wherein the epoxide/amine ratio of components A to B is between 0.75:1 and 1.25:1.

One constituent of the two-component binding-agent composition according to the present invention is made up of component A, a polymer based on polyesters, polyamides, poly(meth)acrylates, polyurethanes, polyolefins, or aromatic polyepoxides. It is necessary according to the present invention for these polymers to comprise at least two epoxide groups per molecule. The epoxide groups can be incorporated via epoxy-functional modules directly upon polymer synthesis; it is alternatively possible, in a polymer comprising double bonds, for the latter to be converted into epoxide groups. A further possibility is to react polymers, having OH groups or having isocyanate groups, with low-molecular-weight epoxide compounds that additionally comprise a group reactive with the OH group or with the isocyanate group.

One class of suitable base polymers is OH-functionalized polyolefins. Polyolefins are known to one skilled in the art and can be obtained at many molecular weights. Such polyolefins, based on ethylene-chain, propylene-chain, or higher-chain α-olefins as homo- or copolymers, can be functionalized either by copolymerization of monomers containing functional groups, or by graft reactions. A further possibility is for these base polymers to be subsequently equipped with OH groups, for example by oxidation.

For example, a further group of base polymers for the manufacture of component (A) can be selected from the group of olefin (co)polymers such as ethylene/acrylate rubber, butyl rubber; natural rubber; styrene copolymers, individually or in a mixture, the copolymers being statistical, alternating, graft, or block copolymers.

Further examples of base polymers are also thermoplastic elastomers (TPE), which are known per se. These are understood to be, for example, thermoplastic rubbers. According to the present invention such thermoplastic elastomers are selected, in particular, from the group of the styrene block polymers, for example styrene-diene copolymers (SBS, SIS), styrene-ethylene/butylene copolymers (SEBS), or styrene-ethylene/propylene-styrene copolymers (SEPS, SEP).

Further olefinic polymers that are suitable as base polymers for the manufacture of component (A) are, for example, homo- or copolymerizates of 1,3-butadiene, of 2-methyl-1,3-butadiene (isoprene), of 2-methyl-1,3-hexadiene, of 2-methyl-1,3-cyclopentadiene, and of further copolymerizable monomers.

The aforementioned olefinic base polymers can contain multiple unsaturated double bonds. These can be contained in the main polymer chain, and/or they are contained in side chains. Vinyl functional groups, in particular, are to be contained. These double bonds can be reacted in accordance with known methods so that the base polymers comprise epoxide groups. The epoxy-group-containing polymers thus obtained are suitable as component (A) in the context of the invention. Further suitable base polymers having a polyolefin structure can contain functional groups, for example OH groups. These can then be reacted, in accordance with known methods, with bifunctional compounds, such that said compounds are to comprise an epoxide group. Polymers having epoxide groups, and suitable for component (A), are obtained.

A further class of suitable base polymers is polyester polyols. These can be obtained by polycondensation of acid and alcohol components, in particular by polycondensation of a polycarboxylic acid or a mixture of two or more polycarboxylic acids, and a polyol or a mixture of two or more polyols. Suitable polycarboxylic acids are those having an aliphatic, cycloaliphatic, aromatic, or heterocyclic basic element. If applicable, instead of the free carboxylic acids, it is also possible to use acid anhydrides thereof or esters thereof with C₁₋₅ monoalcohols for polycondensation.

A plurality of polyols can be used as diols for reaction with the polycarboxylic acids. For example, aliphatic polyols having 2 to 4 primary or secondary OH groups per molecule, and 2 to 20 carbon atoms, are suitable. Portions of higher-functional alcohols can likewise be used. Polyether polyols can also be used as a diol component. Polyether polyols are obtained preferably by reacting low-molecular-weight polyols with alkylene oxides, for example the reaction products of ethylene glycol, propylene glycol, or the isomeric butanediols with ethylene oxide, propylene oxide, or butylene oxide. Methods for manufacturing such polyester polyols are known to one skilled in the art, and these products are commercially obtainable.

A further class of base polymers contains a polyamide backbone. Polyamides are reaction products of diamines with di- or polycarboxylic acids. It is possible, by targeted synthesis, to introduce terminal OH groups into polyamides.

A further class of base polymers is polyols based on acrylates. These are polymers manufactured by polymerizing (meth)acrylic esters, such as acrylic-acid, methacrylic-acid, crotonic-acid, or maleic-acid esters. Usual C₁ to C₁₅ alkyl esters of (meth)acrylic acid are preferably polymerized.

Monomers carrying OH groups can also be contained in this context. Other copolymerizable monomers can optionally also be contained. Other suitable poly(meth)acrylates are to comprise at least two OH groups. These can preferably be present terminally in the polymer. OH-functional poly(meth)acrylates of this kind are known to one skilled in the art. They can then be functionalized to yield epoxide groups, in accordance with known methods. Another procedure directly yields acrylate polymers having epoxide groups; here monomers that contain glycidyl groups are polymerized in. Suitable polymerization methods are known to one skilled in the art.

The OH groups of the base polymers can be reacted, in accordance with known methods, with low-molecular-weight compounds that contain an epoxide group and a group that reacts with the OH group. Examples of such groups are NCO groups, halogens, anhydrides, or esters. After reaction, polymers are obtained that comprise epoxide groups and are suitable as component A.

A further class of suitable base polymers is polyurethanes. These can be manufactured by reacting polyols, in particular diols and/or triols, with di- or triisocyanate compounds. The quantitative ratios are selected in this context so that terminally NCO-functionalized prepolymers are obtained. The polymers are, in particular, to be linear, i.e. to be manufactured predominantly from diols and diisocyanates. Additional use of small proportions of trifunctional monomers is possible.

The polyols and polyisocyanates usable in the context of synthesis of the PU polymers are known to one skilled in the art. These are the monomeric aliphatic, cycloaliphatic, or aromatic polyisocyanates known for adhesive use; in particular, di- or triisocyanates are used. Known oligomers such as biurets or isocyanurates can also be used. These are reacted, for example, with those polyols that are also known as a polyol for the synthesis of polyesters, in particular with diols.

Methods for manufacturing the PU prepolymers are likewise known to one skilled in the art. The quantity of isocyanates is selected, at a stoichiometric excess, in such a way that NCO-functional PU prepolymers are obtained. A buildup of molecular weight in the context of synthesis can be avoided by selection of the NCO:OH ratio. The proportion of non-reacted residual monomers in the prepolymer can likewise be decreased by selecting asymmetrical isocyanates. Another type of manufacture distills an excess of unreacted isocyanates out of the reaction mixture. The isocyanate groups can then be reacted with alcohols that contain epoxide groups.

The known polyepoxide resins that carry at least two epoxide groups per molecule are preferably suitable as polymers having epoxide groups. The epoxide equivalent of these polyepoxides can be selected within broad limits, for example between 50 and 1000 g/mol epoxide. The polyepoxides can in principle be saturated, unsaturated, cyclic or acyclic, aliphatic, alicyclic, aromatic, or heterocyclic polyepoxide compounds. Examples of suitable polyepoxides include the known polyglycidyl ethers, which are manufactured by reacting epichlorohydrin with a polyphenol in the presence of alkali. Polyphenols suitable for this are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)1,1-isobutane, 4,4′-dihydroxybenzophenone, bis(4-hydroxyphenyl)1,1-ethane, or 1,5-hydroxynaphthalene. It is also possible to react corresponding amino compounds to yield epoxy resins. Aromatic hydroxyalkyl or aminoalkyl aromatic compounds can likewise be reacted. Epoxy resins flowable at room temperature, which as a rule have an epoxide equivalent weight from 50 to approximately 300 g/mol epoxide, are used in particular.

In a particularly preferred embodiment, component A refers to epoxide compounds of formula (II) that comprise an aromatic nucleus:

R³-ring-(—CH₂—N(R⁴)_{b})_{c} (II)

where
R³=H, CH₃, C₂H₅
b=1 or 2
c=1, 2, 3 or 4
R⁴═C₃ to C₈ alkyl having an epoxide group
ring=phenyl, biphenyl, naphthyl.

This aromatic nucleus can encompass, for example, phenyl, diphenyl, naphthyl units, which if applicable can also carry alkyl substituents. Preferably b=2 and c=2 or 3. These are, in particular, modules that are not substituted in the para-position with the functional residues. Suitable examples of such aromatic nuclei are 1,3-substituted phenyls, 2,2′- or 2,4′-substituted biphenyls, 2,4′-substituted methylenediphenyl structures. Epoxide-group-substituted derivatives of m-xylylenediamine, of m-xylylenediisocyanate, or of resorcinol are particularly suitable.

The polyepoxide compounds of component A that are suitable according to the present invention are to comprise 2 to 10 epoxide groups, in particular 2, 4, or 6 per molecule. A particular embodiment of the polyepoxide compound comprises the epoxide groups at the chain end, or as a side-chain end, of a compound. The polyepoxide compounds can be present individually or as a mixture having different structures.

In order to obtain suitable application properties such as viscosity or cohesion, the molecular weight (number-average molecular weight M_{N}, as determinable by GPC), is to be between 200 and 10,000 g/mol, preferably 250 to 5000 g/mol, in particular 250 to 2500 g/mol. Fairly low molecular weights are preferred for solvent-free adhesives; higher molecular weights can also be selected for solvent-containing systems.

The binding-agent system according to the present invention contains, as a component B crosslinking with component A, aromatic compounds that must comprise primary amino groups. These are compounds of formula (I)

R¹-phenyl-(—R²)ₐ (I)

where
R¹=H, C₁ to C₆ alkyl
a=1, 2 or 3
R²=—O—CH₂—CHOH—CH₂—NH—CH₂-phenyl-CH₂—NH₂,
preferably a=2 or 3, and R¹=H.

These compounds can be manufactured, for example, from aromatic glycidyl ethers that are reacted with an excess of diaminoalkylbenzene. Suitable di- or triepoxides having aromatic nuclei are, in particular, the reaction products of pyrocatechol, resorcinol, hydroquinone, pyrogallol, phloroglucinol, 2,4-hydroxytoluene, optionally also 1,3- or 1,5- or 1,6-naphthol. These can be reacted with, for example, epichlorohydrin or analogous compounds to yield di- or triepoxide-substituted compounds. As an aromatic diamine for further reaction, xylylenediamine (XDA), in particular mXDA, is suitable in particular as an amine component.

The quantitative ratio of amino groups in the diamine (such as XDA) to the glycidyl groups is to be selected so that an excess of amino groups is present, and all the epoxide groups are reacted. An epoxide-free component B is thus produced. In an embodiment, the epoxide/NH ratio is to be equal to 0.9:4 to 1.1:4 (calculated as H-acid NH groups). Another embodiment selects the quantity of epoxide groups with respect to the quantity of NH functionality in such a way that an excess of incompletely reacted XDA is present. In this case component B is a mixture of XDA and a compound of formula (I). The starting materials are to be selected in this context so that at most 50 wt % (based on component A) unreacted diamine is contained. A further embodiment selects the quantitative ratios for the manufacture of component B so that a molecular weight buildup occurs. The epoxide/NH ratio can, in this context, be equal to e.g. from 1.1:4 to 1.6:4.

The reaction for the production of hardener component B suitable according to the present invention is known. In this, the suitable di- or triepoxide compounds are mixed with the corresponding quantity of XDA, in particular mXDA, and reacted, if applicable with slight heating. This can also be carried out, if applicable, in solvents, which can be removed by distillation, if required, after the reaction.

The compounds suitable according to the present invention as component B comprise primary amino groups. They furthermore contain secondary amino groups as well as additionally OH groups. The molecular weight of these compounds can be equal to between approx. 450 and 2500 g/mol, in particular up to approx. 1500 g/mol.

Two-component compositions according to the present invention are to be manufactured from the suitable epoxy resins as component A and the polyamino compounds of component B. The two components are mixed in a liquid state, such that the ratio of amino groups (as NH group) to epoxide groups is to be approximately equimolar. In particular, the ratio is equal to approx. 0.75:1 to 1.25:1, in particular 0.95:1 to 1.05:1, in order to avoid an excess of unreacted amino groups. The two components are stored separately, and mixed before processing. The constituents then crosslink.

Two-component laminating adhesives can be manufactured from the compositions described above. It is useful for additional constituents, for example solvents, plasticizers, catalysts, stabilizers, adhesion promoters, pigments, or fillers, to be contained in these laminating adhesives.

In an embodiment, the adhesive that is suitable according to the present invention contains at least one tackifying resin. The resin produces additional tackiness. All resins that are compatible, i.e. that form a largely homogeneous mixture, can be used in principle. These can be, for example, aromatic, aliphatic, or cycloaliphatic hydrocarbon resins, as well as modified or hydrogenated derivatives thereof. The resins generally possess a low molecular weight below 1500 g/mol, in particular below 1000 g/mol. The resin can be used in a quantity from 0 to 50 wt %, preferably up to 20 wt %, based on the adhesive.

Plasticizers can also be contained, for example white mineral oils, naphthenic mineral oils, paraffinic hydrocarbon oils, polypropylene, polybutene, polyisoprene oligomers, hydrogenated polyisoprene and/or polybutadiene oligomers, phthalates, adipates, benzoate esters, vegetable or animal oils, and derivatives thereof. Those plasticizers that are unobjectionable in terms of food regulations are particularly suitable.

Phenols, high-molecular-weight sterically hindered phenols, polyfunctional phenols, sulfur- and phosphorus-containing phenols, or amines are suitable as optionally usable stabilizers or antioxidants.

It is possible additionally to add silane compounds to the adhesive as adhesion promoters. The known organofunctional silanes such as (meth)acryloxy-functional, epoxy-functional, amine-functional, or non-reactively substituted silanes can be added can be used as adhesion promoters. Examples thereof are vinyltrialkoxysilane, alkyltrialkoxysilane, tetraalkoxysilane, 3-acryloxypropyltrialkoxysilane, 3-methacryloxypropyltrialkoxysilane, 3-aminopropyltrimethoxysilane, 3-aminopropyltriethoxysilane, 3-aminopropylmethyldimethoxysilane, N-(2-aminoethyl)-3-aminopropyltrimethoxysilane, 3-g lycidyloxymethyltrimethoxysilane, 3-g lycidyloxymethyltriethoxysilane, 2-glycidoxyethyltrimethoxysilane, or corresponding dialkoxy derivatives; butoxy, propoxy, in particular methoxy or ethoxy groups are preferably suitable. In a preferred embodiment, 0.1 to 5 wt % of such silanes are added to the adhesive. Depending on the selection of the silane, it is useful to mix it into only one component. A premature reaction, and a decrease in shelf stability, can thereby be prevented.

An adhesive according to the present invention can also contain catalysts as an optionally additionally present additive. All known compounds that can catalyze the reaction of the amino group and epoxide group can be used as catalysts. Examples thereof are titanates such as tetrabutyl titanate or titanium tetraacetyl acetonate; bismuth compounds such as bismuth tris-2-ethylhexanoate; tin carboxylates such as dibutyltin dilaurate (DBTL), dibutyltin diacetate, or dibutyltin diethylhexanoate; tin oxides such as dibutyltin oxide and dioctyltin oxide; organoaluminum compounds such as aluminum trisacetylacetonate; chelate compounds such as zirconium tetraacetylacetonate; amine compounds or salts thereof with carboxylic acids, such as octylamine, cyclohexylamine, benzylamine, dibutylamine, monoethanolamine, triethanolamine, diethylenetriamine, triethylenetetramine, triethylenediamine, guanidine, morpholine, N-methylmorpholine, and 1,8-diazabicyclo-(5,4,0)-undecene-7 (DBU); silane compounds having amino groups. The catalyst is used in a quantity from 0.01 to approximately 5 wt % based on the total weight of the adhesive, preferably from 0.05 to 1 wt %, particularly preferably more than 0.1 wt %.

A particular embodiment of the invention further adds pigments to the coating agents. These are finely particulate pigments, for example having a particle size<5 μm. An embodiment of the invention works with flaked pigments that can be dispersed into one component of the binder. They are then present in finely distributed form, i.e. the pigments or fillers are dispersed in flake form, meaning that they have little thickness. Such pigments are known to one skilled in the art, for example sheet silicates of various compositions. Another procedure utilizes nanopigments. These usually have a particle size<500 nm, in particular less than 100 nm. These nanopigments can be, for example, those based on TiO₂, SiO₂, Fe₂O₃, or similar oxides or oxyhydrates. Such pigments are known to one skilled in the art, who can select them based on usual considerations and finely disperse them, by means of known methods, in one or both binding-agent components.

According to the present invention the adhesives can also contain solvents. These are the usual solvents that can evaporate at temperatures of up to 120° C. The solvents can be selected from the group of the aliphatic hydrocarbons, the aromatic hydrocarbons, ketones, in particular C₁ to C₄ alcohols, or also water. In a preferred embodiment, the two-component adhesive is solvent-free.

Because the adhesives are, in particular suitable for coating large areas, they are to have a low viscosity at an application temperature from approx. 20 to 90° C. The viscosity of the laminating adhesives according to the present invention, measured immediately after mixing of the constituents, is to be between 200 and 5000 mPas at application temperature, preferably 300 to 3000 mPas (at 20 to 60° C., Brookfield viscosimeter, per EN ISO 2555).

The known flexible films can be used as film materials for the manufacture of multi-layer films. These are substrates made of thermoplastics in film form, for example polyolefins such as polyethylene (PE) or polypropylene (PP, CPP, OPP), polyvinyl chloride (PVC), polystyrene (PS), polyesters such as PET, polyamide, organic polymers such as cellophane; metal foils or paper are also possible as substrates. The film materials can also be modified, for example by modifying the polymers with functional groups, or additional components, for example pigments, dyes, or foamed layers can be contained in the film. The films can be colored, imprinted, colorless, or transparent.

In the two-component laminating adhesives, the known adjuvants and additives can be added to component A or to component B provided the latter do not react with the additives. Solvents can be contained, although a particular embodiment of the invention works in solvent-free fashion. It is possible in particular, by way of the selection of component A and component B, to ensure that at room temperature (such as 25° C.) a low-viscosity mixture of components A and B is obtained.

The adhesive according to the present invention can be used in particular as a laminating adhesive. The adhesives are, in this context, applied in a thin layer onto a film. Immediately thereafter, the optionally contained solvents are to evaporate; a second film is then applied onto the adhesive layer and compressed under pressure. The selection according to the present invention, having low viscosity, also allows solvents to be avoided.

A particular embodiment of the invention consists in making available a water-soluble two-component adhesive. It is advantageous in this context if the components comprise an elevated number of polar groups in order to exhibit improved water solubility or water miscibility. In this case it is additionally advantageous to use emulsifiers or dispersion adjuvants as further constituents. These, even in small quantities, assist the ability of the components to disperse in water. The emulsifiers are to be mixed in quantities from 0.1 to 5 wt %, based on the composition. After mixing of the two components and crosslinking, a network forms. This is no longer water-soluble, but nevertheless has good barrier properties.

A further embodiment of the invention uses the two-component compositions for two-component covering agents. These covering agents can, in principle, contain the same constituents as those described for the laminating adhesives. Care must be taken in terms of selection, however, that the covering agents exhibit a smooth, non-tacky surface after crosslinking. Good adhesion is to exist only with respect to the substrate on which the coating agent is applied in liquid form.

One skilled in the art is familiar with those constituents that are to be used only in small quantities, or to be avoided, in the manufacture of non-tacky surfaces. Examples of such constituents are small quantities of plasticizer, small quantities of tackifying resins, or binding agents having a low glass transition temperature.

Also a subject of the present invention is a multi-layer film that is adhesively bonded using a laminating adhesive suitable according to the present invention; the known plastic films, for example those made of polypropylene, polyethylene, polyester, PVC, polyamide, or others, can be used in this context as substrates. A continuous layer is produced on this film using an adhesive according to the present invention, and immediately after application is bonded to a second identical or different film. In addition to the two-layer films, it is likewise possible to produce a multi-layer film using further working steps. An embodiment according to the present invention works with transparent films; for this, it is useful if the adhesive according to the present invention is likewise transparent and not colored. Other non-plastic films can also be contained in these multi-layer films, for example paper or metal foils.

A particularly advantageous property of the adhesive layers according to the present invention is an elevated barrier effect of the layer. It has been demonstrated that aroma chemicals have more difficulty penetrating through such multi-layer films than through conventionally bonded films. Improved stability with respect to the diffusion of gases, for example oxygen, or water vapor is also noted.

The adhesive according to the present invention exhibits good adhesion between the various layers. It exhibits no bubbles or defects in the adhesive layer.

A further subject of the invention is use of the composition according to the present invention to manufacture coatings on flexible composite substrates. The additives and adjuvants indicated above can, in this context, be contained in the coating agent. The coating agents are liquid, or can be applied in flowable fashion by being heated to up to 90° C. These coatings are flexible after crosslinking, and for that reason can be used in particular for flexible multi-layer films. A preferred embodiment applies the coating agents according to the present invention at an application temperature between 20 and 60° C. The viscosity measured at this temperature is to equal from 200 to 3000 mPas, in particular up to 1500 mPas.

After crosslinking, solid layers that are not tacky at the surface are obtained. Such films can be further processed in known fashion; either additional lamination layers are applied, or they are packaged.

The suitable binding agents can be further processed in simple fashion into two-component coating agents or two-component adhesives. When these adhesives or coating agents are used on film substrates, composite films having excellent barrier properties are obtained. The barrier properties can refer to a variety of constituents; for example, the diffusion of oxygen can be decreased. Another embodiment decreases the diffusion of water. It is furthermore possible to decrease the diffusion of aroma chemicals.

The composite films manufactured according to the present invention exhibit a high level of flexibility. They can be embodied in transparent fashion, i.e. they contain only nanoparticles as fillers, or no fillers; but the layers can also be colored or pigmented. Adhesion to the various substrate materials is good. No separation between adhesively bonded surfaces is observable even in a context of mechanical stress on the composite materials, for example the adhesively bonded films. Packages, for example, can be manufactured from the composite materials according to the present invention. As a result of the barrier effect, such packages are suitable for sensitive items, for example for foods or pharmaceutical goods.

### EXAMPLE 1

Adhesive, according to the present invention

Component A: Tetraglycidyl-m-xylylenediamine, epoxide equivalent weight approx. 102 g/mol epoxide.

Component B: m-resorcinol diglycidyl ether is reacted with m-xylylenediamine at a molar ratio of 1:3 (amine equivalent weight approx. 55 g/mol NH).

An adhesive is manufactured from 1.5 parts A and 1.0 parts B. The components are mixed at 40° C. and applied at that same temperature. Crosslinking is observable after 60 minutes.

### EXAMPLE 2

A binding-agent system is manufactured analogously to Example 1. 0.5% DBTL, contained in component B, is added to this as a catalyst.

After mixing, the two-component adhesive (Example 1 and Example 2) has a viscosity of 1000 mPas at 40° C.

Further experiments

| Additional constituent | Quantity (wt %) | Example no. |
|---|---|---|
| Ethyl acetate | 30 | 3 |
| Ethanol | 15 | 4 |
| Colophon resin | 5 | 5 |
| Ethyl acetate | 5 | |
| Aminosilane AMMO | 1.5 | 6 |
| UV stabilizer | 1 | 7 |

A variety of additives are introduced into the adhesive according to Example 1. The quantities indicated refer to the entire two-component adhesive mixture. The resin, stabilizer, and adhesion promoter are mixed into component B; the solvents according to Examples 3 and 4 are added to both components in the same proportion.

### Comparative Experiment 8

A commercially usual polyurethane laminating adhesive of the Henkel company (commercial name: UR 7782 with UR 6083) is mixed.

The one component in this context is made up of an OH-containing polyester binding agent (molecular weight approx. 2200 g/mol), and the crosslinker component is made up of aromatic isocyanate prepolymers based on TDI reaction products. The two components are mixed at an NCO:OH ratio of approx. 1:1, and used as a laminating adhesive.

The following films are adhesively bonded to one another:

PET (polyethylene terephthalate) (approx. 12 μm)

PE (polyethylene)

OPP (oriented polypropylene)

OPA (oriented polyamide)

SiOx-PET (siloxane-coated polyethylene terephthalate)

Thin layers (2 g/m²) of adhesives 1, 2, and 8 are applied onto the film substrates using a laboratory coater, and immediately thereafter are bonded to a second film. After storage for 48 hours at room temperature (25° C.), permeability is determined.

TABLE
(O₂ permeability)

| | Adhesive | | | Comp. | Comp. |
|---|---|---|---|---|---|
| | Ex. 1 | Ex. 1 | Ex. 2 | Ex. 8 | Ex. 8 |
| | Condition | Condition | Condition | Condition | Condition |
| Film | 1 | 2 | 1 | 1 | 2 |
| PET/EP | 23.7 | 24.5 | 24 | 115 | 102 |
| OH/OH | 47.5 | 51 | 45.5 | 145 | 135 |
| OPP/PE | 33 | 30 | 31 | 160 | 145 |
| PE/PET- | 11.8 | 10 | 11 | 19 | 15 |
| SiOx | | | | | |
| OPA/PE | 15 | 14 | 13 | 60 | 45 |

Condition 1: measured=OTR at 50% relative humidity, standard pressure O₂; permeability (cm³/m²·24 h·1 bar)

Condition 2: measured=OTR at 0% relative humidity, standard pressure O₂; permeability (cm³/m²·24 h·1 bar)

(O₂ permeability per DIN 53380)

The barrier effect of the adhesive according to the present invention is better than that of PU adhesives.

TABLE
(adhesion)

| Film | Ex. 1 | Ex. 2 | Comp. Ex. 8 |
|---|---|---|---|
| OPP/OPP | 2.1 | 2.0 | 1.8 |
| OPP/PE | 2.3 | 2.2 | 1.7 |
| OPA/PE | 1.9 | 2.5 | 1.9 |
| PET/PE | 2.6 | 2.3 | 1.9 |

Measured: Instron adhesion, 2 days crosslinking at room temperature (N/15 mm), per DIN 53504.

The test bonds were produced as indicated above.

Adhesively bonded OPP/OPP films of Examples 3, 4, 5, and 6 were also analogously produced and tested for adhesion.

Adhesion is better than that of the comparison adhesive.

What is claimed is:

1. A two-component composition consisting of a component A containing a polymer having a molecular weight from 250 to 5000 g/mol and having at least two epoxide groups per molecule, a component B containing a compound of formula (I)
R¹-phenyl-(—R²)ₐ (I)
where
R¹=H, C₁ to C₆ alkyl
a=1, 2 or 3
R²=—O—CH₂—CHOH—CH₂—NH—CH₂-phenyl-CH₂—NH₂
wherein the epoxide/NH ratio of components A to B is between 0.75:1 and 1.25:1.

2. The two-component composition according to claim 1, wherein polymer A is selected from poly(meth)acrylate, polyolefin, polybutadiene, polyester, polyamide, polyurethane, or aromatic polyepoxide resin.

3. The two-component composition according to claim 1, wherein component A contains a compound of formula (II):
R³-ring-(—CH₂—N(R⁴)_{b})_{c} (II)
where
R³=H, CH₃, C₂H₅
b=1 or 2
c=1, 2, 3 or 4
R⁴=C₃ to C₈ alkyl having an epoxide group
ring=phenyl, biphenyl, naphthyl.

4. The two-component composition according to claim 3, wherein compound (II) comprises a phenyl ring, where R³=H, R⁴=C₃ to C₅ alkyl having a terminal epoxide group, and b=2 and c=2 or 3.

5. The two-component composition according to claim 1, wherein component B additionally contains up to 50 wt % mXDA.

6. The two-component composition according to claim 5, wherein component B is produced as a reaction product of aromatic epoxides containing an aromatic ring and two or three glycidyl ether substituents with mXDA having a ratio of epoxide group to NH groups of 0.5:4 to 1.6:4.

7. The two-component composition according to claim 1, wherein component A is an epoxide polymer based on a xylylenediamine and component B contains at least 50% of a polyamine which is a reaction product of xylylenediamine with epoxide group-containing resorcinol, pyrogallol, phloroglucinol, or hydroxyhydroquinone.

8. The two-component composition according to claim 1, additionally containing one or more of catalysts, solvents, water, plasticizers, adhesion promoters, resins, neutralizing agents, emulsifiers, stabilizers, and/or pigments.

9. The two-component composition according to claim 8, wherein the adhesive contains C₁ to C₄ alcohols or water as solvent, or is free of organic solvents.

10. The two-component composition according to claim 8, wherein 0.1 to 5 wt % silanes having 1, 2, 3, or 4 hydrolyzable groups are contained as adhesion promoters.

11. The two-component composition according to claim 8, wherein 0.1 to 5 wt % aminosilanes, epoxy silanes or both are contained as adhesion promoters.

12. The two-component composition according to claim 8, wherein the viscosity immediately after mixing the components is equal to 200 mPas to 5000 mPas (measured in accordance with EN ISO 2555 at application temperature) measured at between 20 and 60° C.

13. A method of making a multi-layer film, comprising:
providing a first film having a surface;
providing the two-component composition according to claim 8;
disposing the two-component composition on the first film surface;
applying a second film over the disposed two-component composition; and
curing the composition wherein cured reaction products of the two-component composition bond the first film to the second film.

14. The method according to claim 13 wherein the first and second layers are each individually selected from polypropylene film, polyethylene film, polyester film, PVC film, polyamide film, polystyrene film, cellophane film, paper and metal foil.

15. A method of coating a flexible film, comprising:
providing a first film having a surface;
providing the two-component composition according to claim 1;
disposing the two-component composition on the first film surface; and
curing the composition wherein cured reaction products of the two-component composition form a flexible coating over the first film surface.

16. The method of claim 15 wherein the flexible film is part of a food package.
